(19) United States
(12) Patent Application Publication
(10) Pub. No.: US 2010/0051717 A1
(43) Pub. Date: Mar. 4, 2010

(54) ULTRASONIC ATOMIZER

(75) Inventor: Shao-Kai Pei, Taipei Hsien (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Taipei Hsien (TW)

(21) Appl. No.: 12/470,472

(22) Filed: May 21, 2009

(30) Foreign Application Priority Data
Aug. 27, 2008 (CN) 200810304244.3

(51) Int. Cl. B05B 1/08

(52) U.S. Cl. 239/102.2

(57) ABSTRACT

An ultrasonic atomizer includes a container, a separating membrane and an ultrasonic oscillator. The container defines an inner chamber therein. The separating membrane is disposed in the inner chamber. The separating membrane partitions the inner chamber into a bottom chamber and a top chamber, the bottom chamber is filled with a noncorrosive liquid. The ultrasonic oscillator is received in the bottom chamber and submerged in the liquid.

### BACKGROUND

1. Technical Field

The present disclosure generally relates to ultrasonic atomizers, and more particularly, an ultrasonic atomizer for forming thin films.

2. Description of Related Art

Recently, ultrasonic spray pyrolysis (USP) technology has been widely applied in forming semiconductor thin films on substrates. A typical USP process includes atomizing a precursor liquid with an ultrasonic oscillator to obtain a plurality of droplets and spraying the droplets onto a surface of a heated substrate.

However, for the purpose of obtaining micron scaled droplets, the ultrasonic oscillator must be submerged in the precursor liquid. When the precursor liquid is corrosive, the ultrasonic oscillator is inevitably corroded.

Therefore, what is needed, is an ultrasonic atomizer capable of overcoming the problems mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of embodiments. Moreover, in the drawings, like reference numerals designate corresponding parts throughout the different views.

FIG. 1 is a schematic view of an ultrasonic atomizer in accordance with a first embodiment.

FIG. 2 is similar to FIG. 1, but showing a step of forming a ruthenium thin film on a substrate using the ultrasonic atomizer provided in the first embodiment.

FIG. 3 is a scanning electron microscope (SEM) photograph of the ruthenium thin film formed accordance with the first embodiment.

FIG. 4 is a schematic view of an ultrasonic atomizer in accordance with a second embodiment.

### DETAILED DESCRIPTION

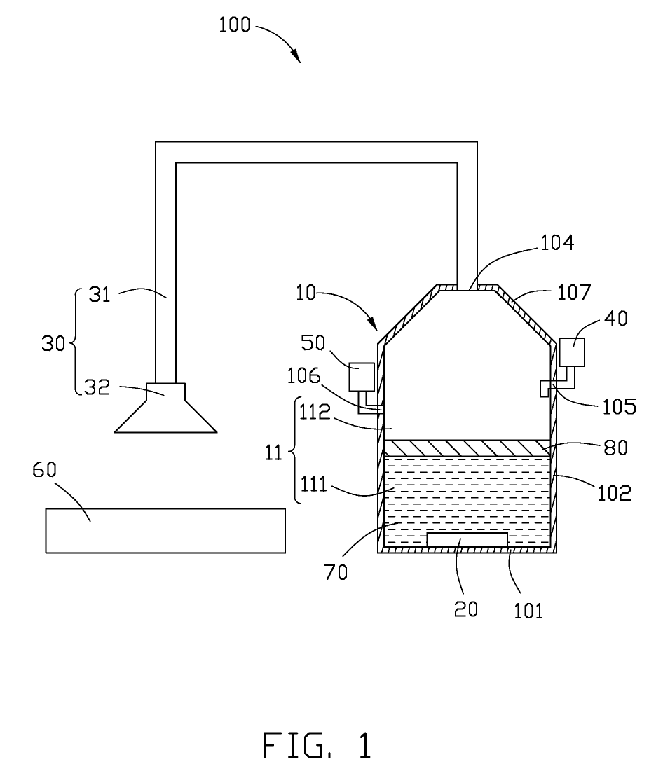

Referring to FIG. 1, an ultrasonic atomizer 100 provided in a first embodiment includes a container 10, a separating membrane 80, an ultrasonic oscillator 20, a noncorrosive ultrasonic transmission liquid 70, a carrier gas supplier 40, a precursor liquid supplier 50, a spraying device 30, and a heater 60.

The container 10 includes a bottom wall 101, a sidewall 102, and a cross sectional trapezium shaped top wall 107. The bottom wall 101 cooperating with the sidewall 102 and a top wall 107 defines an inner chamber 11. The separating membrane 80 is received in the chamber 11 with edge portion of the separating membrane 80 fixed on the sidewall 102, made of anti-corrosive material and capable of transmission of ultrasonic waves therethrough, such as polyethylene. In this manner, the chamber 11 is partitioned into a bottom chamber 111 for accommodating the ultrasonic oscillator 20 and ultrasonic transmission liquid 70, and a top chamber 112 for accommodating precursor liquid. The top wall 107 defines a top outlet 104 communicated with the top chamber 112. The sidewall 102 defines a carrier gas inlet 105 and a precursor inlet 106 both adjacent to the separating membrane 80 and communicated with the top chamber 112. For the purpose of preventing corrosion by the precursor liquid, the container 10 can be made of stainless steel or other anti-corrosive materials.

The ultrasonic oscillator 20 is received in the bottom chamber 111. The ultrasonic oscillator 20 is a piezoelectric device capable of vibrating and generating a ultrasonic wave with a frequency of 2.0 MHz-13 MHz in response to an appropriate electrical signal applied thereto, and is configured for atomizing the precursor liquid into droplets.

The bottom chamber 111 is filled with the ultrasonic transmission liquid 70 to a level where the liquid 70 contacts the separating membrane 80. The ultrasonic oscillator 20 is submerged in the ultrasonic transmission liquid 70. In such manner, the ultrasonic oscillator 20 is cooled by the liquid 70 to protect it from being damaged by too much heat generated during mechanical vibration, and the ultrasonic wave and the mechanical vibration produced by the ultrasonic oscillator 20 are transmitted to the top chamber 112 through the separating membrane 80. The ultrasonic transmission liquid 70 is noncorrosive, and may be selected from the group consisting of water, methanol, ethanol, and acetone.

The carrier gas supplier 40 is communicated with the top chamber 112 through the carrier gas inlet 105 and configured for supplying carrier gas such that droplets generated from the precursor liquid in the top chamber 112 flow into the spraying device 30 with the carrier gas. The carrier gas is inert, such as nitrogen gas, argon and so on.

The precursor supplier 50 is communicated with the top chamber 112 through the precursor inlet 106, configured for compensating precursor liquid into the top chamber 112 to retain the precursor liquid at a predetermined level under control of a device such as a flowmeter.

The spraying device 30 includes a duct 31 and a nozzle 32. An end of the duct 31 is communicated with the top chamber 112 through the top outlet 104, another end of the duct 31 is communicated with the nozzle 32. A diameter of the duct 31 is less than that of the top chamber 112 such that droplets are prevented from forming through condensation and attaching on an inner surface of the duct 31 prior to arrival at the nozzle 32. The nozzle 32 is opposite to the heater 60, configured for spraying the droplets onto the heater 60. A diameter of the nozzle 32 is larger than that of the duct 31 and gradually increases along a direction away from the duct 31 such that the droplets can be diffusely sprayed onto the heater 60.

The heater 60 is configured for heating a substrate to be coated to a predetermined temperature. In this way, when sprayed onto the substrate, the droplets dry, forming a thin film on the substrate.

A method for forming a thin film on a substrate using an ultrasonic pyrolysis spray technology will be illustrated, taking a process of forming a thin ruthenium film on a substrate as an example.

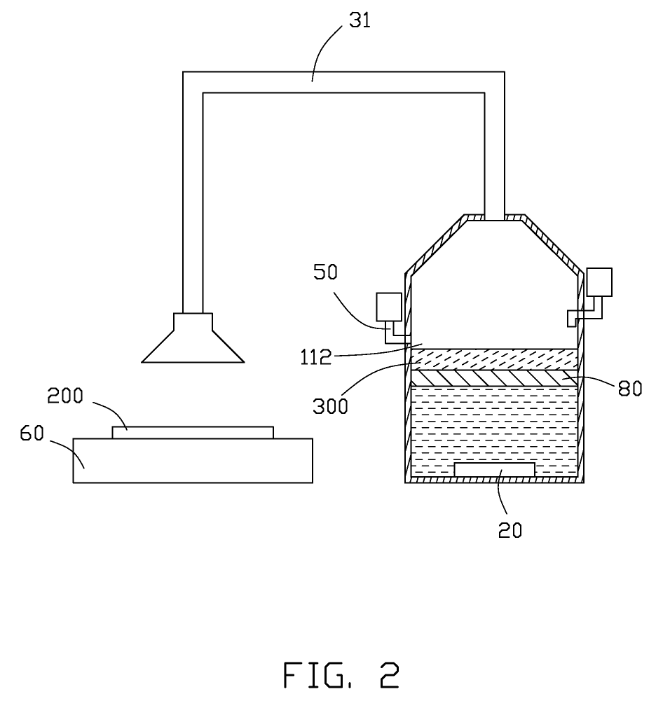

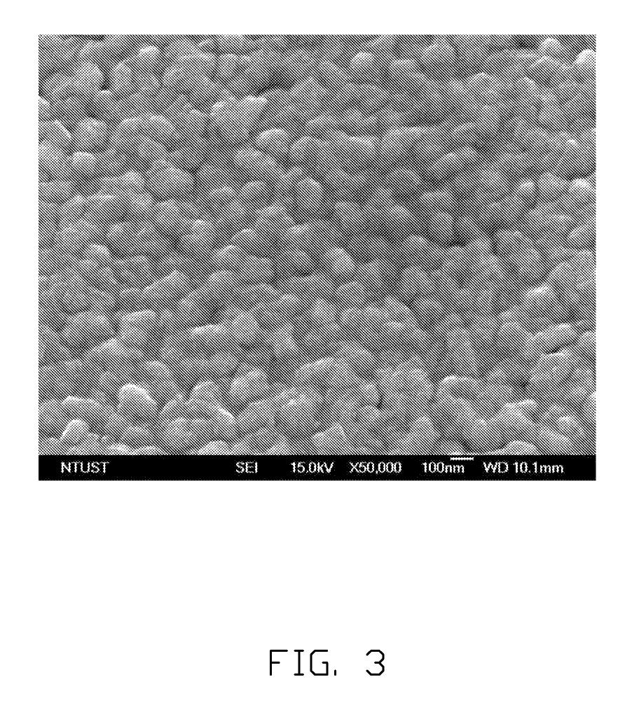

Referring to FIG. 2, the method includes following steps. Firstly, 100 ml 0.001 mol/L precursor liquid 300 is filled into the top chamber 112 with the precursor liquid supplier 50. Thereafter, the separating membrane 80 is entirely covered. The precursor liquid 300 is a mixture of tri(pentane-2,4-keto)ruthenium and methanol. Secondly, a substrate 200 is placed on the heater 60 and heated to a predetermined temperature, such as 300° C. Thirdly, the ultrasonic oscillator 20 is switched on. A carrier gas of 100 sccm is introduced or forced into the top chamber 112. Therefore, the precursor liquid 300 is atomized into a plurality of droplets under the ultrasonic energy generated by the ultrasonic oscillator 20, the droplets subsequently flow into the duct 31 with the carrier gas onto the substrate 200. The droplets arrive at the substrate 200, and dry. After about 30-60 minutes, a thin film of nano scaled (see FIG. 3) ruthenium oxide is formed on the substrate.

In the illustrated embodiment, the separating membrane 80 is employed to separate the ultrasonic oscillator 20 from the precursor liquid and transmit the ultrasonic into the precursor liquid. Therefore, the ultrasonic oscillator 20 is protected from being corroded by corrosive precursor liquid.

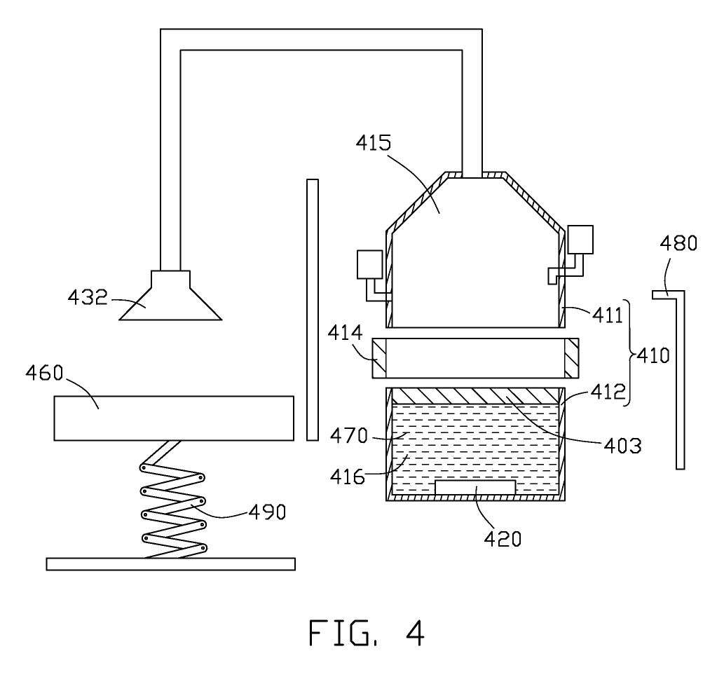

Referring to FIG. 4, another ultrasonic atomizer 400 provided in a second embodiment differs from the ultrasonic atomizer 100 in that the ultrasonic atomizer 400 further includes a joint ring 414. The container 410 includes a top portion 411 and a bottom portion 412. The separating membrane 403 is sandwiched between the top portion 411 and the bottom portion 412 with the joint ring 414 surrounding the top portion 411 and the bottom portion 412. Therefore, the top portion 411 cooperates with the separating membrane 403 to define a top chamber 415 for accommodating precursor liquid and the bottom portion 412 cooperates with the separating membrane 403 to define a bottom chamber 416 for accommodating an ultrasonic oscillator 420 and ultrasonic transmission liquid 470. In this embodiment, the joint ring 414 is made of TEFLON so that it is anti-corrosive.

The apparatus 400 further includes an infra-red (IR) detector 480, a lift table 490 and a separating plate 450. The IR detector 480 is opposite to the top portion 411, and is configured for measuring diameters of droplets generated in the top chamber 415. To facilitate measuring the droplets, the top portion 411 is made of transparent materials, such as glass. The separating plate 450 is disposed between the heater 460 and the container 410 to prevent the container being damaged by the heat generated by the heater 460. The lift table 450 is connected to the heater 460 to remove the heater 460 to a predetermined position relative to the nozzle 432.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An ultrasonic atomizer, comprising:
a container defining an inner chamber therein;
a separating membrane disposed in the inner chamber, the separating membrane partitioning the inner chamber into a bottom chamber and a top chamber, the bottom chamber being filled with a noncorrosive liquid; and
an ultrasonic oscillator received in the bottom chamber and submerged in the liquid.

2. The ultrasonic atomizer of claim 1, wherein the separating membrane isolates the top chamber from the bottom chamber.

3. The ultrasonic atomizer of claim 1, further comprising a duct and a nozzle, the duct being interconnected between and communicating with the top chamber and the nozzle.

4. The ultrasonic atomizer of claim 3, wherein a diameter of the nozzle gradually increases along a direction away from the duct.

5. The ultrasonic atomizer of claim 1, further comprising a joint ring, the container comprising a top portion and a bottom portion, the separating membrane being sandwiched between the top portion and the bottom portion, the top portion being connected to the bottom portion with the joint ring.

6. The ultrasonic atomizer of claim 5, wherein the top portion of the container is made of a transparent material.

7. The ultrasonic atomizer of claim 1, further comprising an infra-red detector opposite to the top portion of the container for detecting sizes of produced droplets in the top chamber.

8. The ultrasonic atomizer of claim 3, further comprising a heater opposite to the nozzle, configured for heating a substrate to a predetermined temperature.

9. The ultrasonic atomizer of claim 8, further comprising a separating plate disposed between the heater and the container for protecting the separating membrane from being damaged.

10. The ultrasonic atomizer of claim 8, further comprising a lift table connected to the heater for moving the heater relative to the nozzle.
